(19) United States
(12) Patent Application Publication
(10) Pub. No.: US 2017/0057517 A1
(43) Pub. Date: Mar. 2, 2017

(54) BEHAVIOR TRAINABLE ADAPTIVE CRUISE CONTROL

(71) Applicant: Continental Automotive Systems, Inc., Auburn Hills, MI (US)

(72) Inventors: Mohammad Shafikul Huq, Hamtramck, MI (US); Douglas A McConnell, Rochester Hills, MI (US)

(73) Assignee: Continental Automotive Systems, Inc., Auburn Hills, MI (US)

(21) Appl. No.: 15/216,770

(22) Filed: Jul. 22, 2016

Related U.S. Application Data
(60) Provisional application No. 62/212,649, filed on Sep. 1, 2015.

(51) Int. Cl. B60W 40/09; B60W 30/14

(52) U.S. Cl. CPC B60W 40/09; B60W 30/14; B60W 2540/30; B60W 2720/10; B60W 2900/00; B60W 2550/30

(57) ABSTRACT

An electronic control unit for adaptive cruise control of a vehicle, comprises an interface operable to receive data from a plurality of sensors and a training module operable to analyze the data and determine a first set of parameters for a first performance mode of the adaptive cruise control system. The first set of parameters is learned based upon the received data. A reading module is operable to read a recorded second set of parameters for a second performance mode, wherein the second set of parameters are read from the received data. A comparison module is operable to select one of the first performance mode and the second performance mode and a controller is operable to receive the set of parameters associated with the selected performance mode, wherein the controller determines desired vehicle actions based on the received set of parameters and send instructions to implement the desired vehicle actions.

### TECHNICAL FIELD

The present disclosure relates to automotive vehicles, and more particularly to adaptive cruise control systems for automotive vehicles.

### BACKGROUND

Automotive vehicles utilize cruise control systems to assist vehicle operators in maintaining vehicles at a constant speed when traveling long distances. Operation of the vehicle in cruise control mode may increase fuel economy over long distances. As is known, the vehicle operator can engage and disengaged the cruise control systems as desired. However, as is known, operation of the cruise control system may be terminated by application of the brakes by the vehicle operator.

Advancements in sensor technology available have led to the ability to improve safety systems for vehicles. Recently adaptive cruise control (ACC) systems have been developed. ACC systems adjust the speed of the vehicle to accommodate changes in traffic speed when operating in cruise control mode. Typically, ACC systems maintain a desired time or distance from a forward vehicle. If the forward vehicle changes speeds or changes lanes the ACC system will return the vehicle to the cruising speed originally set by the vehicle operator. As with standard cruise control systems, the ACC systems may be terminated by application of the vehicle brakes.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A electronic control unit for adaptive cruise control of a vehicle, comprises an interface operable to receive data from a plurality of sensors within the vehicle and a training module operable to analyze the data and determine a first set of parameters for a first performance mode of the adaptive cruise control system, wherein the first set of parameters are learned based upon the received data. A reading module is operable to record a second set of parameters for a second performance mode of the adaptive cruise control system, wherein the second set of parameters are read from the received data. A comparison module is operable to select one of the first performance mode and the second performance mode and a controller is operable to receive the set of parameters associated with the selected performance mode, wherein the controller determines desired vehicle actions based on the received set of parameters and send instructions to implement the desired vehicle actions.

An adaptive cruise control system for vehicle operation, comprises a plurality of vehicle sensors operable to provide data regarding vehicle information, a vehicle bus operable to implement instructions to a plurality of vehicle systems, and an electronic control unit coupled to the plurality of sensors. The electronic control unit is configured to determine a first set of parameters and read a second set of parameters, to select between the first and second set of parameters, and to communicate to vehicle bus instructions for the vehicle to implement based on the second set of parameters.

A method of adapting cruise control in a vehicle comprises receiving data from a plurality of vehicle sensors, and analyzing the data with a training module to determine a first set of parameters for a first performance mode of the adaptive cruise control system, wherein the first set of parameters are learned based upon the data. A second set of parameters are recorded for a second performance mode of the adaptive cruise control system with a reading module, wherein the second set of parameters are read from the received data. One of the first performance mode and the second performance mode are selected with a comparison module and a desired vehicle action is determined with a controller based on the selected set of parameters. Instructions are sent to a vehicle bus to implement the desired vehicle actions.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a of a vehicle having a disclosed behavior trainable ACC system; and

FIG. 2 is a schematic illustration of the ACC system utilizing the behavior training.

### DETAILED DESCRIPTION

The following description is merely exemplary in nature and is in no way intended to limit the disclosure, its application, or uses. For purposes of clarity, the same reference numbers will be used in the drawings to identify similar elements.

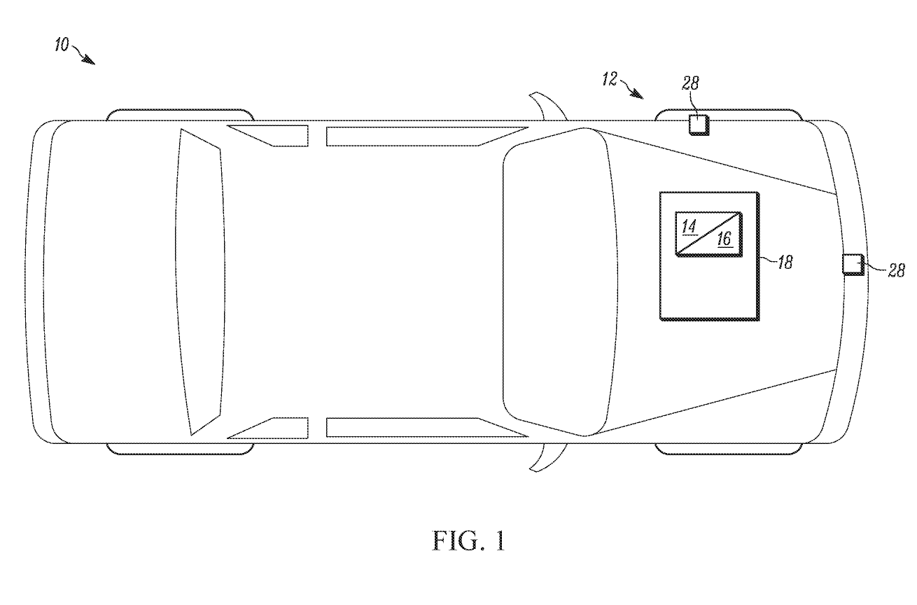

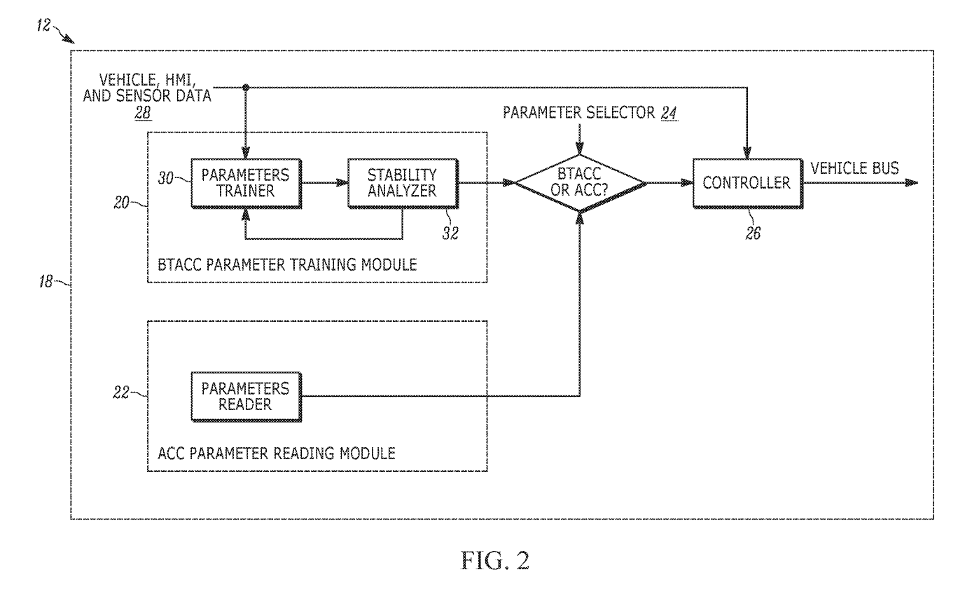

Referring to FIGS. 1 and 2, a vehicle 10 including a behavior trainable adaptive cruise control (BTACC) system 12 is schematically shown. The BTACC system 12 can operate in either an ACC mode 14 or a BTACC mode 16. In ACC mode 14, the BTACC system 12 provides cruise control which adapts the speed of the vehicle 10 to maintain a desired distance or time behind a following vehicle. Additionally, in BTACC mode 16, the BTACC system 12 adapts the vehicle response, including speed, based on learned behaviors for a vehicle driver.

The BTACC system 12 includes a set of parameters that determine how the BTACC performs when in the BTACC mode 16, that is when vehicle response is desired and instructed from the BTACC system 12. Some of the parameters are tunable to some degree through human-machine interfaces (HMI). Other parameters are predetermined. The BTACC is able to learn these parameters from the driving behavior of the driver. The learned parameters are implemented when the BTACC system 12 is in BTACC mode 16.

The BTACC system 12 includes an electronic control unit (ECU) 18 which executes an algorithm to implement the BTACC system 12. The ECU 18 may be specific to the BTACC system 12 or may be part of the vehicle ECU. Within the ECU 18, there is a BTACC training module 20, an ACC reading module 22, a parameter selector 24, and controller 26.

To determine the parameters for operation in BTACC mode 16, the ECU 18 for the BTACC system 12 collects driving data, through a plurality of sensors 28 for the vehicle 10. The sensors 28 provide information such as, set speed, acceleration, deceleration, head way setting, etc. The BTACC system 12 records and measures the driver habit by collecting this information over time during operation of the vehicle 10, when the BTACC system 12 is not in use and when the BTACC system 12 is operating in ACC mode 14.

The information collected by the BTACC system 12 includes acceleration, deceleration, head way distances, etc at various speeds and other situation parameters. The information from the various scenarios is analyzed to model typical behavior for that driver in that given scenario. Further information from regarding driver preference is learned when the driver varies or overrides when operating in ACC mode 14 for that given scenario.

The BTACC system 12 may start being trained from a default setting or one of several default settings and adjust those settings as the BTACC system 12 is trained over time by the driver behavior. The controller 18 continually updates the parameters from the driving data and thereby continuously updates and improves the performance of BTACC mode 16 according to driver preferred behavior.

In one embodiment, the sensors 28 record typical headway distances at various speeds when the driver is not using ACC mode 14 or BTACC mode 16. The BTACC system 12 then alters the BTACC headway information based on this learned driver preference. In another embodiment. the BTACC system 12 can record when the driver overrides when operating in ACC mode 14 to learn driver preference, e.g. by overriding ACC to speed up and close a headway distance or to brake and increase the headway distance, and adjust the BTACC headway information from this learned driver preference as well.

A further embodiment of trainable behavior involves when a driver accelerates or decelerates due to traffic. The driver preferred acceleration or deceleration rate for a particular scenario can be learned by the BTACC system 12 and applied when in BTACC mode 14. Alternately in another embodiment trainable behavior involves when the system operates in ACC mode 14 and the vehicle 10 or the other vehicle changes lanes requiring acceleration or deceleration of the vehicle 10. That is, when the vehicle 10 is entering or leaving a following situation while operating in ACC mode 14. In such instance, if the driver overrides the default ACC acceleration or deceleration rate this can be used for training the BTACC system 14.

After the BTACC system 12 has collected sufficient data, the driver is able to drive the vehicle in BTACC mode 16. In BTACC mode 16, the BTACC system 12 will provide instructions to the vehicle 10 to implement desired vehicle maneuvers based on the learned driving behavior. Thus, providing the driver, especially young or elderly driver, with a high level of comfort.

Referring to FIG. 2, the BTACC training module 20 uses the vehicle, HMI and sensor 28 data to learn the parameters. BTACC training module 20 includes a parameters trainer 30 and a stability analyzer 32. The parameters trainer 30 interprets the data to provide a set of learned parameters. The stability analyzer 32 then evaluates the parameters and decides in the parameters are stable enough to implement the BTACC mode 16. That is, the stability analyzer 32 evaluates the parameters and determines if there is sufficient data collected from various driving scenarios to adapt a BTACC setting, e.g. acceleration, deceleration, headway at a particular speed. It may take weeks, or months for enough data to be collected for the stability analyzer 32 to determine a trained behavior is stable enough to implement within BTACC mode 16.

Further some parameters may have sufficient information to be assessed as stable by the stability analyzer 32 and operate in BTACC mode 16, while others may not and will operate in ACC mode 14. For example, the BTACC system 12 may know a preferred headway distance at a certain speed, but a preferred deceleration rate may not be known. If the system 12 determines a deceleration is needed the default rate for that situation will be used. In other words, BTACC always works during driving if it either has parameters trained enough or has default parameters inherited from ACC.

The parameters trainer 30 continually updates the parameters from the driving data the stability analyzer 32 continually updates the stability evaluation to improve the performance and increase the stability of the BTACC mode 16.

For operating in ACC mode 14, the reading module 22 reads the driver selected parameter from the parameters reader. For example, the driver can select between three levels of ACC operation providing a more relaxed or more aggressive following patterns. The BTACC system 12 then begins the learning mode from the set point selected within the ACC mode 14. Further, in another embodiment, the BTACC system 12 may also allow the operator to select from various operating patterns when operating in BTACC mode 16. Based on the selected BTACC mode 16 operating pattern the parameters are interpreted by the ECU 18 to range from a more relaxed operating behavior, a normal operating behavior, and a more aggressive operating behavior.

As shown, a parameter selector 24 can be embedded within the ECU 18 for the BTACC system 12. The parameter selector 24 provides the output of whether the BTACC system 12 should operate in ACC mode 14 or BTACC mode 16 and provides the corresponding set of parameters to the controller 18. The controller 18 uses the parameters to determine the desired vehicle action and send instructions to the various vehicle systems through the vehicle bus 34. The driver may choose either ACC mode 14 of BTACC mode 16 by inputting the decision into the parameter selector 24 through HMI. Alternately, the parameter selector 24 can choose between ACC mode 14 and BTACC mode 16 based on information from the stability analyzer 32 regarding the stability of the parameters available for BTACC mode 16.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A electronic control unit for adaptive cruise control of a vehicle, comprising:
an interface operable to receive data from a plurality of sensors within the vehicle;
a training module operable to analyze the data and determined a first set of parameters for a first performance mode of the adaptive cruise control system, wherein the first set of parameters are learned based upon the received data;
a reading module operable to read a second set of parameters for a second performance mode of the adaptive cruise control system, wherein the second set of parameters are read from the received data;
a comparison module operable to select one of the first performance mode and the second performance mode; and
a controller operable to receive the set of parameters associated with the selected performance mode, wherein the controller determines desired vehicle actions based on the received set of parameters and send instructions to implement the desired vehicle actions.

2. The electronic control unit as recited in claim 1, wherein the training module further comprises a parameters trainer, wherein the parameters trainer interprets the data to determine learned behavior and resolve the first set of parameters.

3. The electronic control unit as recited in claim 2, wherein the training module further comprises a stability analyzer to evaluates the first set of parameters and decide if the parameters are stable enough to implement the first performance mode.

4. The electronic control unit as recited in claim 2, wherein the parameters trainer determines the learned behavior based on one of a plurality operating pattern ranging from relaxed operating behavior to aggressive operating behavior.

5. The electronic control unit as recited in claim 1, wherein the comparison module selects between the first performance mode and the second performance mode based on a driver selection input included in the received data.

6. The electronic control unit as recited in claim 1, wherein the comparison module selects between the first performance mode and the second performance mode based on information from the stability analyzer.

7. An adaptive cruise control system for vehicle operation, comprising:
a plurality of vehicle sensors operable to provide data regarding vehicle information;
a vehicle bus operable to implement instructions to a plurality of vehicle systems; and
an electronic control unit coupled to the plurality of sensors, the electronic control unit being configured to determine a first set of parameters and read a second set of parameters, to select between the first and second set of parameters, and to communicate to vehicle bus instructions for the vehicle to implement based on the second set of parameters.

8. The electronic control unit as recited in claim 7, further comprising:
an interface operable to receive the data;
a training module operable to analyze the data and determined the first set of parameters for a first performance mode;
a reading module operable to record the second set of parameters for a second performance mode;
a comparison module operable to select one of the first performance mode and the second performance mode; and
a controller operable to receive the set of parameters associated with the selected performance mode, and send the instructions to the vehicle bus.

9. The electronic control unit as recited in claim 8, wherein the training module further comprises a parameters trainer to interpret the data and determine learned behavior to resolve the first set of parameters, and a stability analyzer to evaluates the first set of parameters and decide if the parameters are stable enough to implement the first performance mode.

10. The electronic control unit as recited in claim 8, wherein the parameters trainer determines the learned behavior based on one of a plurality operating pattern ranging from relaxed operating behavior to aggressive operating behavior.

11. The electronic control unit as recited in claim 8, wherein the comparison module selects between the first performance mode and the second performance mode based on a driver selection input included in the received data.

12. The electronic control unit as recited in claim 8, wherein the comparison module selects between the first performance mode and the second performance mode based on information from the stability analyzer.

13. A method of adapting cruise control in a vehicle comprising:
receiving data from a plurality of vehicle sensors;
analyzing the data with a training module to determine a first set of parameters for a first performance mode of the adaptive cruise control system, wherein the first set of parameters are learned based upon the data;
recording a second set of parameters for a second performance mode of the adaptive cruise control system with a reading module, wherein the second set of parameters are read from the received data;
selecting one of the first performance mode and the second performance mode with a comparison module;
determining desired vehicle actions with a controller based on the selected set of parameters; and
sending instructions to a vehicle bus to implement the desired vehicle actions.

14. The method as recited in claim 13, further comprising interpreting the data with a parameters trainer to determine learned behavior and resolve the first set of parameters.

15. The method as recited in claim 14, further comprising interpreting the data based on one of a plurality operating patterns ranging from relaxed operating behavior to aggressive operating behavior.

16. The method as recited in claim 14, further comprising evaluating the first set of parameters with a stability analyzer to decide if the parameters are stable enough to implement the first performance mode.

17. The method as recited in claim 13, further comprising selecting with the comparison module between the first performance mode and the second performance mode based on a driver selection input included in the received data.

18. The method as recited in claim 13, further comprising selecting with the comparison module between the first performance mode and the second performance mode based on information from the stability analyzer.
